(19) United States
(12) Patent Application Publication
(10) Pub. No.: US 2022/0078209 A1
(43) Pub. Date: Mar. 10, 2022

(54) ENHANCED TRUSTED APPLICATION MANAGER UTILIZING INTELLIGENCE FROM A SECURE ACCESS SERVER EDGE (SASE)

(71) Applicant: Cisco Technology, Inc., San Jose, CA (US)

(72) Inventors: Rajesh I V, Bangalore (IN); Rammohan Ravindranath, Bangalore (IN); Prashanth Patil, San Jose, CA (US); Vinay Saini, Bangalore (IN)

(21) Appl. No.: 17/014,875

(22) Filed: Sep. 8, 2020

(51) Int. Cl. H04L 29/06; H04L 29/12; H04L 29/08

(52) U.S. Cl. CPC H04L 63/20; H04L 61/1511; H04L 63/105; H04L 63/0823; H04L 67/2809

(57) ABSTRACT

A trusted application manager (TAM) includes a processor, and a non-transitory computer-readable media storing instructions that, when executed by the processor, causes the processor to perform operations comprising obtaining, from a secure access service edge (SASE) device executing a security service, a data set defining intelligence provided by the security service, defining a policy based at least in part on the intelligence provided by the security service, and managing a trusted application (TA) based on the policy.

### TECHNICAL FIELD

The present disclosure relates generally to a trusted application manager (TAM) that performs life-cycle management of trusted applications (TAs) within a trusted execution environment (TEE). More specifically, this disclosure relates to an enhanced TAM (E-TAM) that leverages additional network intelligence provided by a secure access service edge (SASE) device to support the management of the TAs.

### BACKGROUND

Infrastructure as a Service (IaaS) are online services that provide high-level application program interfaces (APIs) used to dereference various low-level details of underlying network infrastructure like physical computing resources, location, data partitioning, scaling, security, and backup, among other network infrastructure. In some IaaS scenarios, a trusted execution environment (TEE) may be implemented that provides a secure area in which isolated execution of code and data such as the trusted applications (TAs) is provided. The Internet of Things (IoT) has been posing threats to critical infrastructure because of weak security in devices. It is desirable that IoT devices prevent malware from manipulating actuators, or stealing or modifying sensitive data, such as authentication credentials in the device. A TEE is one way to implement such IoT security functions.

A trusted application manager (TAM) may be used to manage the life-cycle management of the TAs within the TEE including installing, deleting, updating, and providing security services for the TEE and any TAs installed thereon, among other management functions. The TAM may be owned and/or administrated over by an application service provider (ASP) by subscribing to a third-party cloud service that provides such a service (Software as a Service (SaaS).

Consumers of a TAM service may enforce certain organization policies including services associated with security and resource management. It is noted here that TEE hardware resources may be expensive to utilize and resource constrained. A TEE may allow many third-party TA developers and vendors from whom a user buys TAs to install the TAs using the TAM. With this unregulated and unsecure provisioning of TAs and installation of the TAs onto a TEE, it is possible that rogue vendors may distribute malicious TAs. Thus, it may fall to the TAM to identify and block malicious TAs. Indeed, trusted execution environment provisioning (TEEP) architectures and protocols may mandate that the malicious TAs be identified and blocked from installation within the TEE. However, in some instances, the TAM may not have access to dynamic domain specific intelligence to determine whether to trust the TA domains and the third-party TA developers and vendors. Similarly, a TAM may be unable to identify and block malicious content associated with a third-party TA. Further, in order to use a TA in the TEE, sensitive information processed by the TA should be processed in a secured manner. Thus, an organization may require knowledge into what secure information is passed to the TAs and if the TAs are authentic for the secure information. Still further, if the TAM is compromised, the TAM may create a situation where significant harm may be caused to the enterprise and/or the users by not managing the secure installation, deletion, updating, and provision of security services for the TEE and any TAs installed thereon. Thus, a trustworthy network that ensures that the TEE and/or the TAM are not negatively impacted may improve a user's experience in reliably and securely utilizing a TA within the TEE.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an example trusted application manager (TAM)-implemented network, according to an example of the principles described herein.

FIG. 2 is a component diagram of example components of an enhanced TAM (E-TAM), according to an example of the principles described herein.

FIG. 3 illustrates a flow diagram of an example method for managing a trusted application (TA) via an E-TAM, according to an example of the principles described herein.

FIG. 4 illustrates a flow diagram of an example method for managing a TA via an E-TAM, according to an example of the principles described herein.

FIG. 5 illustrates a computing system diagram illustrating a configuration for a data center that may be utilized to implement aspects of the technologies disclosed herein.

FIG. 6 illustrates a computer architecture diagram showing an example computer hardware architecture for implementing a computing device that may be utilized to implement aspects of the various technologies presented herein.

### DESCRIPTION OF EXAMPLE EMBODIMENTS

### Overview

An organization such as a corporation may utilize enterprise software and/or hardware to create various classes of applications in a cloud infrastructure. As used in the present specification and in the appended claims, the term “enterprise” is meant to be understood broadly as any collection of software and/or hardware and the corporation or other entity that execute or otherwise utilize the systems and methods described herein. For example, the enterprise may include the SASE 124 and any of its sub-elements (e.g., an enhanced trusted application manager (E-TAM) 102, a domain name system (DNS) layer security 126 services, a secure web gateway (SWG) 128 service, firewall 130 service, a cloud access security broker (CASB) 132 service, and an interactive threat intelligence (ITI) 134 service, among others), a software-defined networking in a wide area network (SD-WAN) 120, a number of network devices 122, and cloud service 104, an IaaS device 106, and other devices described herein. Some of the applications executed by the enterprise may process sensitive and/or highly confidential data. However, the applications executing in a device may be exposed to many different attacks resulting in data leakage. These attacks may increase with the number of other applications on the device coming from potentially untrustworthy sources. The trusted execution environment (TEE) is designed to execute applications in a protected environment wherein policies are enforced such that any code within the TEE may not be compromised by external applications. Vendors such as, for example, Intel® Software Guard Extensions (SGX), and ARM® TrustZone, among others, may provide TEE hardware and Infrastructure as a Service (IaaS) providers such as, for example, Microsoft® Azure, and Amazon® Web Services (AWS), among other may support confidential cloud computing by offering TEE enabled hardware for the consumers. However, the security requirements and the multitude of vendors and differing implementations may result in interoperability issues in the TEE.

Trusted Execution Environment Provisioning (TEEP) achieves interoperability, compatibility, and proper use of existing TEE-relevant application layer interfaces. TEEP is utilized to manage trusted application(s) (TAs) with a trusted application manager (TAM). The TAM may be owned by an application service provider (ASP) or may be provided by subscribing to a third-party cloud service that provides a TAM service.

This disclosure describes systems and methods for managing trusted applications (TAs) within an Infrastructure as a Service (IaaS) device including a trusted execution environment (TEE) using an enhanced trusted application manager (E-TAM). The E-TAM utilizes intelligence obtained from a secure access service edge (SASE). The intelligence supplied by the SASE may be used in defining and enforcing a number of policies used by the E-TAM to manage the TAs within the TEE.

Examples described herein provide a trusted application manager (TAM) includes one or more processors, and one or more non-transitory computer-readable media storing instructions that, when executed by the one or more processors, cause the one or more processors to perform operations comprising obtaining, from a secure access service edge (SASE) device executing at least one security service, at least one data set defining intelligence provided by the at least one security service, defining at least one policy based at least in part on the intelligence provided by the at least one security service, and managing a trusted application (TA) based on the at least one policy.

Managing the TA includes installing the TA on a trusted execution environment (TEE) executed on an infrastructure as a service (IaaS) device based at least in part on the at least one policy, identifying reserved hardware of the IaaS device onto which the TA is to be installed, and initiating a TA install message to a trusted execution environment provisioning (TEEP) agent via a TEEP broker of the IaaS device to install the TA on the reserved hardware. The operations further include communicating with a TEEP broker of an IaaS device. The communication includes an authentication certificate and authenticating the TAM with respect to a TEEP agent of the IaaS based at least in part on the authentication certificate. The at least one security service executed by the SASE includes a domain name system (DNS) layer security service, a secure web gateway (SWG) service, a firewall service, a cloud access security broker (CASB), an interactive threat intelligence service, and combinations thereof.

The operations further include storing the intelligence of the at least one security service in a data store and storing the at least one policy in the data store. The operations further include identifying a malicious TA based at least in part on the intelligence of the at least one security service and blocking the malicious TA from install on a TEE based at least in part on the at least one policy. The operations further include identifying malicious content of the TA based at least in part on the intelligence of the at least one security service and blocking the malicious content from access to a TEE based at least in part on the at least one policy.

The operations further include periodically inspecting the TA for a compromise to the TA based at least in part on the intelligence of the at least one security service and correcting the compromise to the TA based at least in part on the at least one policy. The operations further including detecting a change to the at least one policy made by the SASE with respect to the TA, and managing the TA based on the change to the at least one policy.

Examples described herein provide a method including obtaining, at a trusted application manager (TAM) and from a secure access service edge (SASE) device executing at least one security service, intelligence data provided by the at least one security service, defining at least one policy based at least in part on the intelligence data provided by the at least one security service, and managing a trusted application (TA) based on the at least one policy. The method further includes installing the TA on a trusted execution environment (TEE) executed on an infrastructure as a service (IaaS) device based at least in part on the at least one policy, identifying reserved hardware of the IaaS device onto which the TA is to be installed, and initiating a TA install message to a trusted execution environment provisioning (TEEP) agent via a TEEP broker of the IaaS device to install the TA on the reserved hardware.

The method further includes authenticating the TAM with respect to a TEEP agent of an IaaS device based at least in part on an authentication certificate, wherein the authentication certificate being added to a trusted anchors database of the IaaS device. The method further includes detecting a change to the at least one policy made by the SASE with respect to the TA, and managing the TA based on the change to the at least one policy. The change to the at least one policy is affected via access provided to an application service provider (ASP) to the SASE. The method further includes storing authentication certificates in a data store of the TAM, the authentication certificates defining access to hardware of an infrastructure as a service (IaaS) device onto which the TA is installed.

Examples described herein provide a non-transitory computer-readable medium storing instructions that, when executed, cause one or more processors to perform operations, include obtaining, at a trusted application manager (TAM) and from a secure access service edge (SASE) device executing at least one security service, intelligence data provided by the at least one security service, defining at least one policy based at least in part on the intelligence data provided by the at least one security service, and managing a trusted application (TA) based on the at least one policy.

The operations further include installing the TA on a trusted execution environment (TEE) executed on an infrastructure as a service (IaaS) device based at least in part on the at least one policy, identifying reserved hardware of the IaaS device onto which the TA is to be installed, and initiating a TA install message to a trusted execution environment provisioning (TEEP) agent via a TEEP broker of the IaaS device to install the TA on the reserved hardware. The operations further include authenticating the TAM with respect to a TEEP agent of an IaaS device based at least in part on an authentication certificate, wherein the authentication certificate being added to a trusted anchors database of the IaaS device. The operations further include detecting a change to the at least one policy made by the SASE with respect to the TA, and managing the TA based on the change to the at least one policy. The change to the at least one policy is affected via access provided to an application service provider (ASP) to the SASE.

Additionally, the techniques described in this disclosure may be performed as a method and/or by a system having non-transitory computer-readable media storing computer-executable instructions that, when executed by one or more processors, performs the techniques described above.

### EXAMPLE EMBODIMENTS

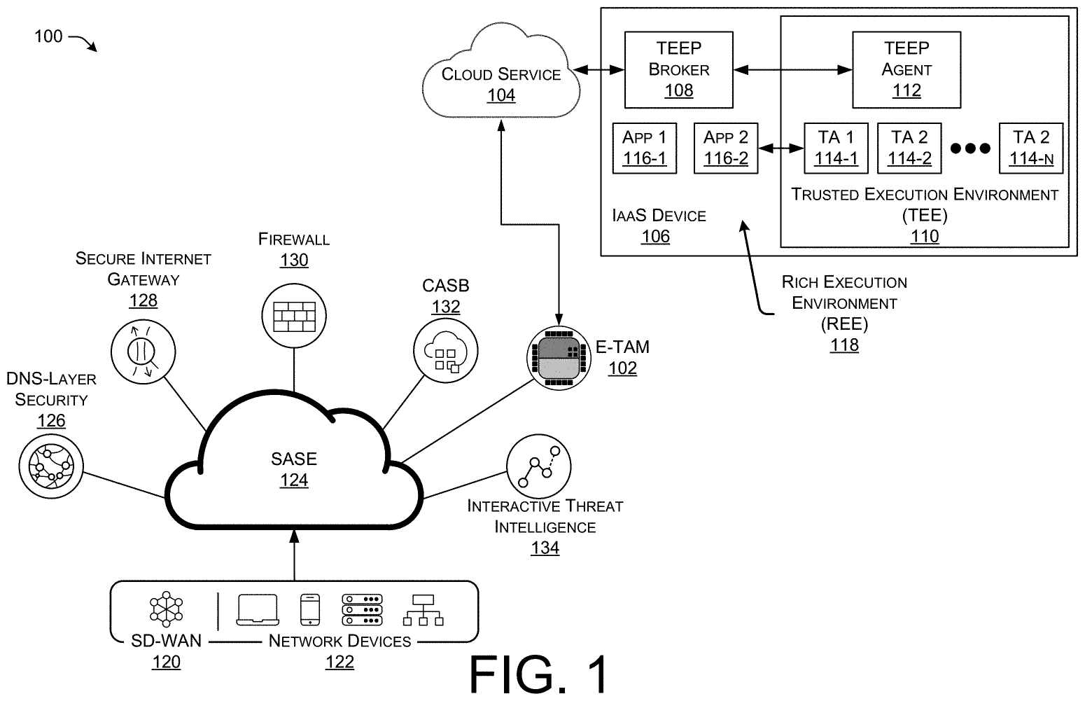

Turning now to the figures, FIG. 1 illustrates a system-architecture diagram 100 of an example trusted application manager (TAM)-implemented network, according to an example of the principles described herein. As discussed above, an enhanced trusted application manager (E-TAM) 102 may utilize intelligence obtained from a secure access service edge (SASE) 124. The intelligence supplied by the SASE 124 may be used in defining and enforcing a number of policies used by the E-TAM 102 to manage a number of trusted applications (TAs) 114-1, 114-2, 114-N, where N, where N is any integer greater than or equal to 1 (collectively referred to herein as TA(s) 114 unless specifically addressed otherwise). The TAs 114 are executed within the trusted execution environment (TEE) 110. Beginning with the Infrastructure as a Service (IaaS) device 106 on which the TEE 110 is executed, the E-TAM 102 may communicate with the IaaS device 106 via a cloud service 104, or, in other words, the IaaS device 106 may be executed within a cloud service 104. A trusted execution environment provisioning (TEEP) broker 108 may be included within the TEE 110. The TEEP broker 108 is an application component running in a rich execution environment (REE) 118 of the IaaS device 106 that enables the message protocol exchange between the E-TAM 1-2 and the TEE 110 in the IaaS device 106. The TEEP broker 108 does not process messages on behalf of a TEE 110, but is, instead, responsible for relaying messages from the E-TAM 102 to the TEE 110, and for returning the TEE's 110 responses to the E-TAM 102. In devices with no REE 118 (e.g., a microcontroller where all code runs in an environment that meets the definition of a TEE 110), the TEEP broker 108 would be absent, and, instead, the TEEP protocol transport would be implemented inside the TEE 110 itself.

The TEEP agent 112 is communicatively coupled to the E-TAM 102 via the TEEP broker 108 and is a processing module running inside a TEE 110 that receives E-TAM 102 requests. The TEEP agent 112 in the TEE 110 may parse requests or forward requests to other processing modules in a TEE 110, which is up to a TEE 110 provider's implementation. A response message corresponding to a request from the E-TAM 102 is sent back to the E-TAM 102 via the TEEP broker 108.

The E-TAM 102 is responsible for performing lifecycle management activity on TAs 114 on behalf of a TA signers and/or a device administrator. TA signers and device administrators utilize the services of the E-TAM 102 to manage TAs 114 on devices. TA signers do not directly interact with devices. Device administrators may elect to use the E-TAM 102 for remote administration of the TAs 114 instead of managing each device directly. The lifecycle management activities performed by the E-TAM 102 may include installation and deletion of TAs 114, and may include, for example, over-the-air updates to keep TAs 114 up-to-date and clean up when a version should be removed. The E-TAM 102 may provide services that make it easier for TA signers or device administrators to use the E-TAM's 12 service to manage multiple devices, although that is not required of the E-TAM 102.

The E-TAM 102 performs its management of TAs 114 on the IaaS device 106 through interactions with the IaaS device's 106 TEEP broker 108, which relays messages between the E-TAM 102 and the TEEP agent 112 running inside the TEE 110. TEEP authentication is performed between the E-TAM 102 and the TEEP agent 112. As depicted in FIG. 1, the E-TAM 102 may not directly contact the TEEP agent 112, but, instead, waits for the TEEP broker 108 to contact the E-TAM 102 requesting a particular service. This architecture is intentional in order to accommodate network and application firewalls that normally protect user and enterprise devices from arbitrary connections from external network entities. In one example, the E-TAM 102 may be publicly available for use by many TA signers. In one example, the E-TAM 102 may be private, and accessible by one or a limited number of TA signers. In one example, a manufacturer and/or network carrier may run a private E-TAM 102.

A TA signer or device administrator may select a particular E-TAM 102 based on whether the E-TAM 102 is trusted by a device or set of devices. The E-TAM 102 is trusted by a device if the E-TAM's 102 public key is, or chains up to, an authorized trust anchor in the IaaS device 106. A trust anchor represents an authoritative entity via a public key and associated data. The public key is used to verify digital signatures, and the associated data is used to constrain the types of information for which the trust anchor is authoritative. The trust anchor may be a certificate, or it may be a raw public key along with additional data if necessary, such as its public key algorithm and parameters.

In one example, a TA signer or device administrator may run their own E-TAM 102, but the devices they wish to manage include this E-TAM's 102 public key/certificate as defined by Request for Comments (RFC) 5280 [RFC5280], or a certificate the public key/certificate chains up to, in a trust anchor store of, for example, the E-TAM 102, the SASE 124 and/or an associated network device 122 communicatively coupled to the SASE 124, a controller of a software-defined networking in a wide area network (SD-WAN) 120 communicatively coupled to the SASE 124, another device associated with the E-TAM 102, and combinations thereof. A TA signer or device administrator is free to utilize a plurality of E-TAMs 102. For example, a plurality of E-TAMs 102 may be utilized in managing TAs 114 on multiple different types of devices from different manufacturers, or mobile devices on different network carriers, since the trust anchor store on these different devices may contain different E-TAMs 102. In one example, a device administrator may be able to add their own E-TAM's 102 public key or certificate to the trust anchor store on all the device administrator's devices, overcoming any issues associated with different devices being communicatively coupled to different E-TAMs 102.

Any enterprise is free to operate the E-TAM 102. For the E-TAM 102 to be effective, the E-TAM 102 may have its public key or certificate installed in a device's trust anchor store. In one example, the E-TAM 102 may set up a relationship with device manufacturers or network carriers to have them install the E-TAM's 102 keys in their device's trust anchor store. Alternatively, the E-TAM 102 may publish its certificate and allow a device administrator to install the E-TAM's 102 certificate in their respective devices as an after-market-action.

Although one E-TAM 102 is depicted in FIG. 1, any number of E-TAMs 102 may be deployed and utilized in the SASE 124. Further, although one TEE 110 is depicted in the IaaS device 106 of FIG. 1, any number of TEEs 110 may be deployed and utilized in the IaaS device 106.

In TEEP, there exists an explicit relationship and dependence between an untrusted application 116-1, 116-2 (collectively referred to herein as untrusted application(s) 116 unless specifically addressed otherwise) in an REE 118 and one or more TAs 114 in a TEE 110, as depicted in FIG. 1. For most purposes, an untrusted application 116 that uses one or more TAs 114 in a TEE 110 appears no different from any other untrusted application 116 in the REE 118. However, the way the untrusted application and its corresponding TAs 114 are packaged, delivered, and installed on the device may vary. The variations depend on whether the untrusted application 116 and TA 114 are bundled together or are provided separately, and this has implications to the management of the TAs 114 in the TEE 110. In addition to the untrusted application 116 and TA(s) 114, the TA(s) 114 and/or TEE 110 may require some additional data to personalize the TA 114 to the device or a user. This personalization data may depend on the type of TEE 110, a particular TEE 110 instance, the TA 114, and even the user of the device. An example of personalization data might be a secret symmetric key used by the TA 114 to communicate with some service. Examples described herein support encryption of personalization data to preserve the confidentiality of potentially sensitive data contained within it and support integrity protection of the personalization data. Other than the requirement to support confidentiality and integrity protection, the TEEP architecture places no limitations or requirements on the personalization data.

There are three possible cases for bundling of an untrusted application 116, TA(s) 114, and personalization data. First, the untrusted application 116, TA(s) 114, and personalization data may be all bundled together in a single package by a TA signer and either provided to the TEEP broker 108 through the E-TAM 102, or provided separately (with encrypted personalization data), with key material used to decrypt and install the personalization data and TA 114 provided by the E-TAM 102. Second, the untrusted application 116 and the TA(s) 114 may be bundled together in a single package, which the E-TAM 102 or a publicly accessible app store maintains. In one example, the personalization data is separately provided by the TA signer's E-TAM 102. Third, all the components may be independent. In this example, the untrusted application 116 may be installed through some independent or device-specific mechanism, and the E-TAM 102 provides the TA 114 and personalization data from the TA signer. Delivery of the TA 114 and personalization data may be combined or separate. The TEEP protocol treats each TA 114, any dependencies the TA 114 has, and personalization data as separate components with separate installation steps that are expressed in SUIT manifests, and a software updates for Internet of Things (SUIT) manifest might contain or reference multiple binaries. The TEEP agent 112 is responsible for handling any installation steps that are performed inside the TEE 110, such as decryption of private TA 114 binaries or personalization data.

Turning now to the SASE 124 of the system-architecture diagram 100 of FIG. 1, the E-TAM 102 may utilize intelligence obtained from the SASE 124. As mentioned above, the intelligence supplied by the SASE 124 may be used in defining and enforcing a number of policies used by the E-TAM 102 to manage the TAs 114. In one example, the SASE 124 is the Umbrella™ network security product suite developed by Cisco®. The SASE 124 provides a myriad of different network intelligence data to the E-TAM 102 as described in more detail herein. The security services provide by the SASE 124 may protect users as well as the IaaS device 106 and its TEE 110 and TAs 114 from malware, botnets, phishing, targeted online attacks, and other security threats that may be encountered within the SASE 124 environment and/or the IaaS device 106 environment.

For example, the SASE 124 may provide domain name system (DNS) layer security 126 services. DNS-layer security services provided by the SASE 124 may include, for example, the ability to create and enforce security policies related to the execution of the devices behind the network perimeter including, for example, the network devices 122 and the IaaS device 106 and its TEE 110 and TAs 114. The SASE 124 may include any type of data-driven threat intelligence engine that automatically updates malware, botnet, and phishing domain and IP blacklists enforced by the SASE 124. The intelligence data may be sourced from DNS requests the SASE 124 receives, and border gateway protocol (BGP) routing tables that are managed by the SASE's 124 network operations center. In this manner, the DNS layer security 126 services allow for security policies to not only be created and executed for the network devices 122 and SD-WAN 120, but also created and executed for the devices within the cloud service 104 including the IaaS device 106 and its TEE 110 and TAs 114. Use of security intelligence provided by the DNS layer security 126 services reduces or eliminates the potential for malicious TAs 114 to be installed and managed on the TEE 110 and reduces or eliminates the potential for malicious content to be introduced in the TEE 110 and the TAs 114. The security intelligence provided by the DNS layer security 126 services may be provided to the E-TAM 102 for use in creating and executing the policies for the devices within the cloud service 104 including the IaaS device 106 and its TEE 110 and TAs 114.

Further, in one example, the SASE 124 may provide a secure web gateway (SWG) 128 service. The SWG 128 service provides, for example, safe internet access to users who do not use a corporate networks or virtual private networks (VPNs) to connect to remote data centers. A SWG 128 provides protection against online security threats by enforcing an enterprise's security policies and by filtering malicious Internet traffic. In one example, the malicious Internet traffic may be filtered in real-time. The SWG 128 provides uniform resource locator (URL) filtering, application controls for web applications, and the detection and filtering of malicious code. Further, the SWG 128 provides data leak prevention services. As to the real-time traffic inspection, the SWG 128 inspects web traffic in real-time, analyzing content against corporate policies and ensuring any content that is inappropriate or which contravenes enterprise policy is blocked. In one example, the SWG 128 may allow an administrator to enforce security policy templates straight off the shelf and also configure policies that are suited to the corporation's business model and/or compliance requirements. Further, the SWG 128 provides roaming users to authenticate seamlessly and to have the same security policies apply to their individual computing devices as if the computing devices were communicatively coupled to the corporation's network. The SWG 128, in this manner, may also be used to protect the devices of the IaaS device 106 and its TEE 110 and TAs 114 as these devices access the Internet and as Internet-related policies are created and executed by the SWG 128. As to data leak prevention, the SWG 128 reduces or eliminates corporate data from being leaked to or stolen by a third party by detecting business terms such as payment card industry (PCI) number patterns and phrases or personally identifiable information. Any security intelligence provided by the SWG 128 may be provided to the E-TAM 102 for use in creating and executing the policies for the devices within the cloud service 104 including the IaaS device 106 and its TEE 110 and TAs 114.

In one example, the SASE 124 may also provide a firewall 130 service. The firewall 130 service monitors and controls incoming and outgoing network traffic based on a number of predetermined security rules and establishes a barrier between a trusted internal network and untrusted external network, such as the Internet. The security services provided by the firewall 130 may be provided to the cloud service 104 and the IaaS device 106 and its TEE 110 and TAs 114. Specifically, security intelligence provided by the firewall 130 may be provided to the E-TAM 102 for use in creating and executing the policies for the devices within the cloud service 104 including the IaaS device 106 and its TEE 110 and TAs 114.

Further, in one example, the SASE 124 may also include a cloud access security broker (CASB) 132 service. A CASB 132 may be any on-premises or cloud-based software that sits between cloud service users and cloud applications and monitors all activity and enforces security policies. The CASB provides a number of services such as monitoring user activity, warning administrators about potentially hazardous actions, enforcing security policy compliance, and automatically preventing malware, among other activity. The CASB 132 may deliver security by preventing high-risk events and/or management by monitoring and mitigating the high-risk events. In one example, the CASB 132 may utilize application program interfaces (APIs) to inspect data and activity in the cloud to alert of risky events after the fact. Further, the CASB 132 may inspect firewall or proxy logs for usage of cloud applications. The same functions provided by the CASB 132 in relation to the SASE 124 may similarly applied to the cloud service 104 and the IaaS device 106 and its TEE 110 and TAs 114. Specifically, security intelligence provided by the CASB 132 may be provided to the E-TAM 102 for use in creating and executing the policies for the devices within the cloud service 104 including the IaaS device 106 and its TEE 110 and TAs 114.

The SASE 124, in one example, may also include an interactive threat intelligence (ITI) 134 service. The ITI 134 service provides intelligence associated with the relationships and evolution of internet domains, IPs, and files to assist in pinpointing attackers' infrastructures and predict future threats. Similarly, to the examples described above, the same functions provided by the ITI 134 in relation to the SASE 124 may similarly applied to the cloud service 104 and the IaaS device 106 and its TEE 110 and TAs 114. Specifically, security intelligence provided by the ITI 134 may be provided to the E-TAM 102 for use in creating and executing the policies for the devices within the cloud service 104 including the IaaS device 106 and its TEE 110 and TAs 114.

The intelligence provided by the SASE 124 may be provided to the E-TAM 102 to create and execute policies based on the intelligence for use in connection with the devices within the cloud service 104 including the IaaS device 106 and its TEE 110 and TAs 114. In one example, data defining intelligence from at least one security service executed by the SASE including the DNS layer security 126 services, a SWG 128 services, a firewall 130 services, CASB 132 services, an ITI 134 services, and combinations thereof may be utilized to manage the TAs 114 within the TEE 110.

In the examples described herein, the E-TAM 102 service provided via the SASE 124 may be offered as one of the security services in the SASE 124. In one example, an enterprise may subscribe to the services provided by the E-TAM 102 for managing the life-cycle of TAs 114 used by the enterprise in different cloud infrastructures with the policies that further the security and functionality of the TAs 114 within the TEE 110. In one example, the enterprise may create a TA 114 in-house for deployment in the TEE 110. In one example, the enterprise may create a TA 114 using an external TA provider. In one example, the enterprise may create a TA 114 using a cloud infrastructure such as a Function as a Service (FaaS) cloud computing services that provides a platform allowing customers to develop, run, and manage the functionalities of the TA 114 without the complexity of building and maintaining the infrastructure associated with developing and launching the TA 114.

In examples where the TA 114 is developed and/or executed by a third-party vendor, it may be possible that rogue vendors distribute malicious TAs 114 which the E-TAM 102 identifies and blocks using the intelligence obtained from the SASE 124 described above. This intelligence obtained from the SASE 124 is utilized by the E-TAM 102 to identify and block the malicious TA domains. Further, the E-TAM 102 may securitize any third-party TAs in order to avoid any potential malicious content. In this example, the E-TAM 102 may utilize the file inspection and intelligent proxy functions of the SASE 124. Thus, the file inspection and intelligent proxy functions of the SASE 124 may be leveraged by the E-TAM 102 to identify potential malicious content. The E-TAM's 102 functionalities may include installing and managing the TAs 114 in the third-party cloud (e.g., cloud service 104 and the associated TEE 110), periodically ensuring the TAs 114 are not compromised and effectively plan resource management by enforcing the corporation's policies.

Before a TA 114 is installed on the TEE 110, the E-TAM 102 may securely attest to the infrastructure provided by the IaaS device 106. In one example, the E-TAM 102 may maintain a hardware profile in storage for future deployment in different cloud services. The infrastructure provided by the IaaS device 106 define any requirements of the TEE 110 the E-TAM 102, the SASE 124, and/or any policy defined by the enterprise. The corporation may reserve the hardware profile for deployment in association with different cloud vendors of a TEE 110. In this example, a secure attestation flow may include both the E-TAM 102 and the TEE 110 verifying each other. The E-TAM 102 may maintain a certificate defining the hardware of the IaaS device 106 and the E-TAM's 102 public certificate. The certificate defining the hardware of the IaaS device 106 and the E-TAM's 102 public certificate may be added to a trust anchor store as a trust anchor. In one example, the trust anchor store may be part of the hardware of the IaaS device 106 and may serve as a method of reserving the hardware from a cloud vendor.

The enterprise may use the services provided by the E-TAM 102 to securely install the TAs 114 in the reserved hardware of the TEE 110. This installation of the TAs 114 may include sequences specified by TEEP protocols. Further, in one example, the E-TAM 102 may maintain in storage data defining information regarding all supported TAs 114, versions of the TAs 114, and other data associated with the deployment of the TAs 114 within the TEE 110.

The enterprise may add a number of policies in the SASE 124 such that TAs 114 from which an application service providers (ASP) may be allowed. Further, the enterprise may define policies related to the periodicity of checking the status of TAs 114 installed on the TEE 110. Still further, the enterprise may define a number of TA 114 deletion policies. Even still further, the enterprise may define a number of TA 114 access restriction policies including restriction policies for corporate network devices 122 and personal network devices 122. Further, the enterprise may define access scheduling associated with the TAs. The policies created and employed within the enterprise may be dynamically updated in the SASE 124 as the enterprise necessitates, instructs, and/or demands.

In an instance of installing a new TA 114 and the enterprise has identified the new TA 114 to be installed on the TEE 110 in the infrastructure of the cloud service 104, the E-TAM 102 service may be invoked with the request. The E-TAM 102 service may perform a policy check of the TA 114, and, if satisfied, may identify reserved hardware within the IaaS device 106 and within the cloud service 104. The E-TAM 102 may then initiate a “TrustedAppinstall” message to the TEEP agent 112 relayed through TEEP broker 108. The E-TAM 102 instructs the TA 114 to be installed within the TEE 110.

The E-TAM 102 provides new and additional options for the SASE 124 package. Specifically, the E-TAM 102 obtains intelligence from other security functions offered in the SASE 124 that assist in the effective management of the TEE 110 within the IaaS device 106 and within the third-party cloud service 104. The E-TAM-implemented network architecture and its associated methods and functions provides a holistic solution for a myriad of security needs that may arise within a TEE 110.

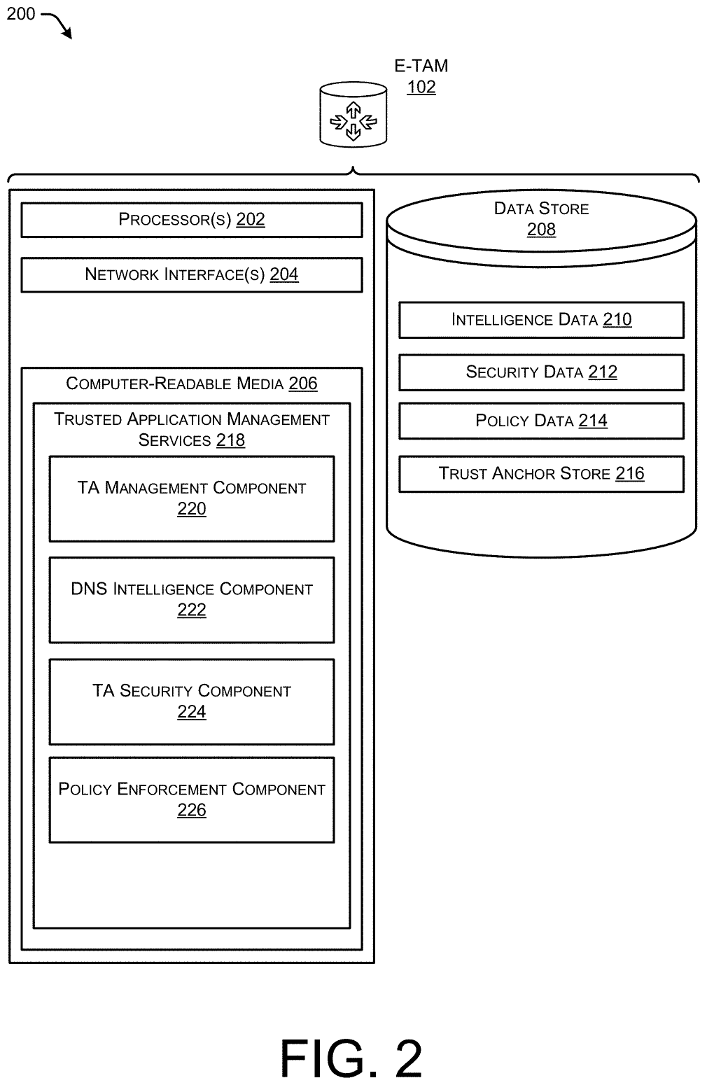

FIG. 2 is a component diagram 200 of example components of an E-TAM 102, according to an example of the principles described herein. As illustrated, the E-TAM 102 may include one or more hardware processor(s) 202, one or more devices, configured to execute one or more stored instructions. The processor(s) 202 may comprise one or more cores. Further, the E-TAM 102 may include one or more network interfaces 204 configured to provide communications between the E-TAM 102 and other devices, such as devices associated with the SD-WAN 120, the network devices 122, devices associated with the DNS layer security 126 services, the SWG 128 services, the firewall 130 services, the CASB 132 services, and the ITI 134 services, devices associated with the cloud service 104, the IaaS device 106 (including the TEEP broker 108, the TEE 110, the TEEP agent 112, and the TAs 114), and/or other systems or devices associated with the E-TAM 102 and/or remote from the E-TAM 102. The network interfaces 204 may include devices configured to couple to personal area networks (PANs), wired and wireless local area networks (LANs), wired and wireless wide area networks (WANs), and so forth. For example, the network interfaces 204 may include devices compatible with the SASE 124, the SD-WAN 120, the cloud service 104, and the IaaS device 106.

The E-TAM 102 may also include computer-readable media 206 that stores various executable components (e.g., software-based components, firmware-based components, etc.). In addition to various components discussed herein, the computer-readable media 206 may further store components to implement functionality described herein. While not illustrated, the computer-readable media 206 may store one or more operating systems utilized to control the operation of the one or more devices that comprise the E-TAM 102. According to one example, the operating system comprises the LINUX operating system. According to another example, the operating system(s) comprise the WINDOWS SERVER operating system from MICROSOFT Corporation of Redmond, Wash. According to further examples, the operating system(s) may comprise the UNIX operating system or one of its variants. It may be appreciated that other operating systems may also be utilized.

Additionally, the E-TAM 102 may include a data store 208 which may comprise one, or multiple, repositories or other storage locations for persistently storing and managing collections of data such as databases, simple files, binary, and/or any other data. The data store 208 may include one or more storage locations that may be managed by one or more database management systems. The data store 208 may store, for example, intelligence data 210 defining intelligence obtained from the DNS layer security 126 services, the SWG 128 services, the firewall 130 services, the CASB 132 services, the ITI 134 services, and other services that may be operated via the SASE 124.

Further, the data store 208 may store security data 212. The security data 212 may include any data obtained by the E-TAM 102 regarding the security of the TAs 114 within the TEE 110 such as, for example, data defining malicious TAs, malicious content, malicious domains, and other data defining security threats to the TAs 114 within the TEE 110.

The data store 208 may also store policy data 214. Policy data 214 may include any data defining past and/or currently executed policies within the E-TAM-implemented network architecture. The policies may be created by an enterprise and stored in the data store 208 of the E-TAM 102 such that the E-TAM 102 may apply them to the management of the TAs 114 within the TEE 110.

Still further, the data store 208 may include a trust anchor store 216. The public keys and/or certificates of the E-TAM 102 may be stored in the trust anchor store 216. Further, the public keys and/or certificates of the IaaS device 106 and its elements including the TEEP broker 108, the TEE 110, the TEEP agent 112, and the TAs 114 may also be stored in the trust anchor store 216. In one example, the trust anchor store 216 may be shared by the devices described herein as may be necessary to authenticate the devices relative to one another.

The computer-readable media 206 may store portions, or components, of a trusted application management service 218. For instance, the trusted application management service 218 of the computer-readable media 206 may include a TA management component 220 to, when executed by the processor(s) 202, install, delete, update, and provide security services for the TEE 110 and any TAs 114 installed thereon. The TA management component 220 may obtain information such as security and intelligence data from the SASE 124 in executing the management of the TAs 114.

The trusted application management service 218 may also include a DNS intelligence component 222 to, when executed by the processor(s) 202, obtain intelligence data from the DNS layer security 126 services, the SWG 128 services, the firewall 130 services, the CASB 132 services, the ITI 134 services, and other services provided by the SASE 124 according to the techniques described herein. The DNS intelligence component 222 may also collect security data associated with accessing and utilizing the devices described herein. The DNS intelligence component 222 may store the data collected in the intelligence data 210 and/or the security data 212 of the data store 208 as described herein.

The trusted application management service 218 may also include a TA security component 224 to, when executed by the processor(s) 202, obtain security data from the SASE 124 and its components including the DNS layer security 126 services, the SWG 128 services, the firewall 130 services, the CASB 132 services, the ITI 134 services, and other services provided by the SASE 124 according to the techniques described herein. The security data may be stored in the security data 212 of the data store 208. Further, the security data obtained by the E-TAM 102 may be used to create policies by the SASE 124 for use in creating and executing the policies for the devices within the cloud service 104 including the IaaS device 106 and its TEE 110 and TAs 114. Still further, the security data obtained by the E-TAM 102 may include data defining malicious TAs, malicious content, and/or malicious code that may be used by the E-TAM 102 to filter the malicious TAs, malicious content, and/or malicious code before being consumed by the cloud service 104 and the TEE 110.

The trusted application management service 218 may also include a policy enforcement component 226 to, when executed by the processor(s) 202, apply a number of policies as defined by the intelligence obtained from the SASE 124 and its components including the DNS layer security 126 services, the SWG 128 services, the firewall 130 services, the CASB 132 services, the ITI 134 services, and other services provided by the SASE 124 according to the techniques described herein. Further, the policy enforcement component 226, when executed by the processor(s) 202, may allow an enterprise to define, create, update, remove, delete, execute, and disseminate a number of policies to other devices based on the intelligence obtained from the SASE 124. Still further, the policy enforcement component 226, when executed by the processor(s) 202, may apply the policies as defined above to the cloud service 104 and the TEE 110 to ensure that malicious TAs, malicious content, and/or malicious code are not introduced to the cloud service 104 and the TEE 110.

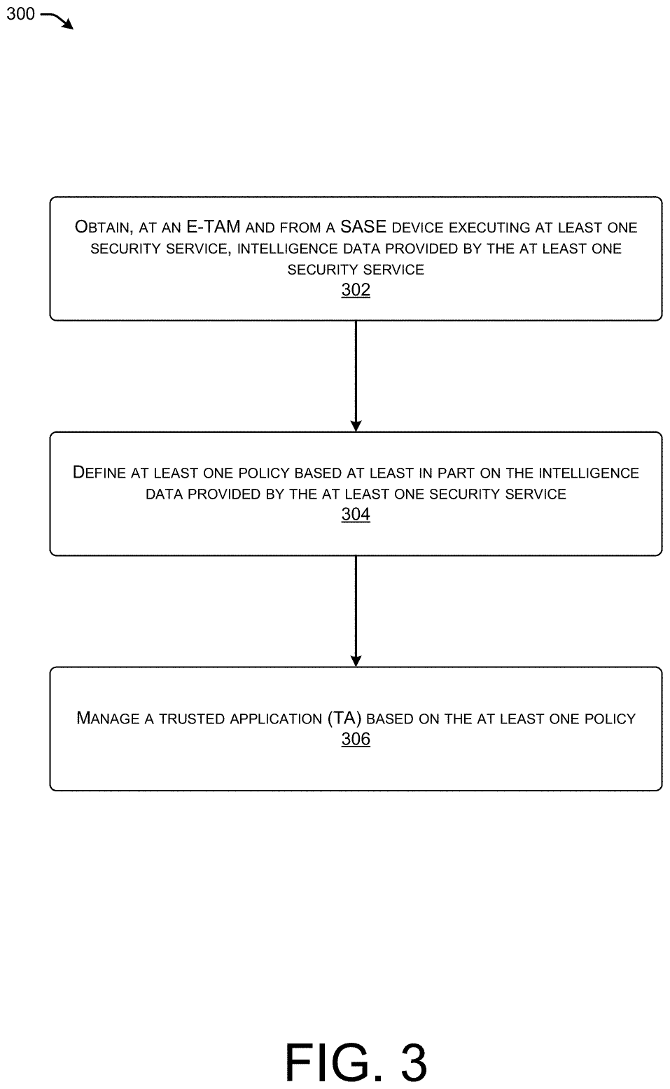

FIG. 3 illustrates a flow diagram of an example method 300 for managing a TA 114 via an E-TAM 102, according to an example of the principles described herein. The method of FIG. 3 may include, at 302, obtaining at the E-TAM 102 and from the SASE 124 device executing at least one security service (e.g., the DNS layer security 126 services, the SWG 128 services, the firewall 130 services, the CASB 132 services, the ITI 134 services, and other services provided by the SASE 124 according to the techniques described herein), intelligence data provided by the at least one security service. The SASE 124, as described herein, provides a suite of different security services 124, 126, 128, 130, 132, 134 that generate several different types of intelligence data that may be used by the E-TAM 102 to enforce policies defined by the enterprise in order to effectively manage TAs 114. Thus, the intelligence gleaned from security services offered through the SASE 124 may be obtained for use by the E-TAM 102.

At 304, the SASE 124, the E-TAM 102 or other enterprise device or administrator may define at least one policy based at least in part on the intelligence data provided by the at least one security service 126, 128, 130, 132, 134 of the SASE 124. The policies may define the manner in which the TAs 114 are installed, deleted, and updated, and the policies define how security services are provided for the TEE 110 and any TAs 114 installed thereon. With the intelligence data provided by the at least one security service 126, 128, 130, 132, 134 of the SASE 124, the E-TAMs 102 functionalities include installing and managing TAs 114 in the third-party cloud, periodically ensuring TAs 114 are not compromised, and effectively planning the resource management of the cloud services 104 by enforcing the enterprise policies defined at 304.

At 306, the E-TAM 102 manages the TAs 114 based on the at least one policy defined at 304. In this manner, the E-TAM 102 may be used to collect intelligence data from the SASE 124, assist in the creation of policies, and manage the TAs 114 within the TEE 110, among other functions. The E-TAM 102 provides security to the devices within the cloud service 104 including the IaaS device 106 and its TEE 110 and TAs 114.

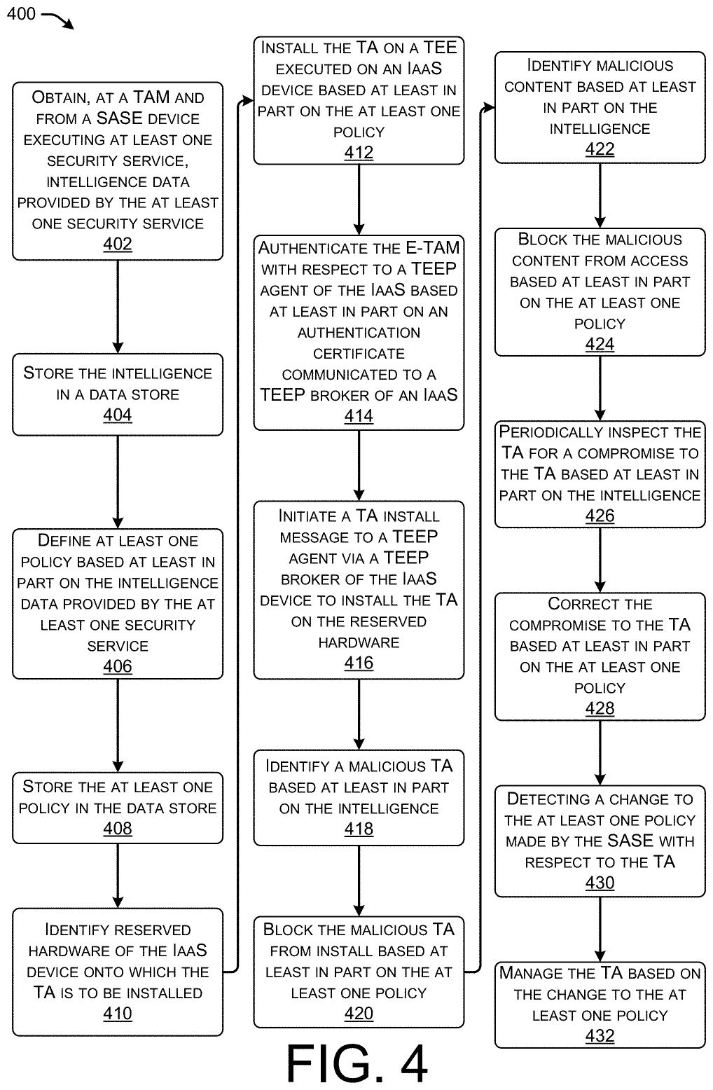

FIG. 4 illustrates a flow diagram of an example method 400 for managing a TA 114 via the E-TAM 102, according to an example of the principles described herein. The method 400 of FIG. 4 includes, at 402, obtaining at the E-TAM 102 and from the SASE 124 device executing at least one security service (e.g., the DNS layer security 126 services, the SWG 128 services, the firewall 130 services, the CASB 132 services, the ITI 134 services, and other services provided by the SASE 124 according to the techniques described herein), intelligence data provided by the at least one security service. At 404, the intelligence of the at least one security service may be stored in the data store 208 as the intelligence data 210.

At 406, the SASE 124, the E-TAM 102 or other enterprise device or administrator may define at least one policy based at least in part on the intelligence data provided by the at least one security service 126, 128, 130, 132, 134 of the SASE 124. As described herein, the policies may define the manner in which the TAs 114 are installed, deleted, and updated, and the policies define how security services are provided for the TEE 110 and any TAs 114 installed thereon. With the intelligence data provided by the at least one security service 126, 128, 130, 132, 134 of the SASE 124, the E-TAMs 102 functionalities include installing and managing TAs 114 in the third-party cloud, periodically ensuring TAs 114 are not compromised, and effectively planning the resource management of the cloud services 104 by enforcing the enterprise policies defined at 404. The policies defined at 406 may be stored the at least one policy in the data store 208 as the policy data 214 at 408.

At 410, the E-TAM 102 may identify reserved hardware of the IaaS device 106 onto which the TA 114 may be installed. The E-TAM 102 may securely attest the hardware within the IaaS device 106 before the TA(s) 114 is installed thereon. The E-TAM 102 may, in one example, maintain the hardware profile of one or more cloud services 104, IaaS devices 106, TEEs 110, REEs 118, and other devices described herein which the enterprise may reserve in different cloud vendors' computing resources. The E-TAM 102 may consider reservation of the hardware based on TEE 110 requirements for the TA(s) 114. In one example, in a secure attestation flow, both the E-TAM 102 and the TEE 110 may be verified by one another. The E-TAM 102 may maintain the certificate of the hardware and the public certificate of the E-TAM 102 in a least one trust anchor store 216 of the E-TAM 102 and/or other device such as the IaaS device 106 and/or the TEE 110 as part of reserving the hardware from the cloud vendor of the cloud service 104.

At 412, the E-TAM 102 may then install one or more TAs 114 on the TEE 110 executed on the IaaS device 106 based at least in part on the at least one policy and the hardware reserved at 410. When installing the TAs 114 or performing any other management process described herein, the E-TAM 102 may communicate with the TEEP broker 108 of the IaaS device 106. The communications from the E-TAM 102 to the TEEP broker 108 may include an authentication certificate. Thus, at 414, the E-TAM 102 may be authenticated with respect to the TEEP agent 112 of the IaaS device 106 based at least in part on the authentication certificate and the communication between the E-TAM 102 and the TEEP broker 108. At 416, TA 114 install message may be initiated to the TEEP agent 112 via the TEEP broker 108 of the IaaS device 106 to install the TA(s) 114 on the reserved hardware.

At 418, the E-TAM 102 may identify a malicious TA that may potentially be installed on the IaaS device 106 based at least in part on the intelligence of the at least one security service (e.g., services provided by the SASE 124). At 420, the E-TAM 102 may block the malicious TA from being installed on a TEE 110 based at least in part on the at least one policy created at 406.

Similarly, at 422, the E-TAM 102 may identify malicious content that may potentially be introduced to the TA(s) 114 or onto the IaaS device 106 based at least in part on the intelligence of the at least one security service (e.g., services provided by the SASE 124). At 424, the E-TAM 102 may block the malicious content from access to the TEE 110 and/or the TA(s) 114 based at least in part on the at least one policy created at 406.

At 426, the E-TAM 102 may periodically inspect the TA(s) 114 for a compromise to the TA(s) 114 based at least in part on the intelligence of the at least one security service (e.g. services provided by the SASE 124) and/or the at least one policy created at 406. The E-TAM 102, at 428, may correct the compromise to the TA(s) 114 based at least in part on the intelligence of the at least one security service (e.g. services provided by the SASE 124) and/or the at least one policy created at 406.

Changes to the intelligence of the at least one security service (e.g. services provided by the SASE 124) and/or the at least one policy created at 406 that relate to the TA(s) 114 may be detected at 430 by the E-TAM 102. The E-TAM 102 may push these changes upstream to the cloud service 104 and to the IaaS device 106 including the TA(s) 114 installed within the TEE 110. Thus, at 432, the E-TAM 102 may manage the TA(s) based on any changes to the at least one policy created a 406.

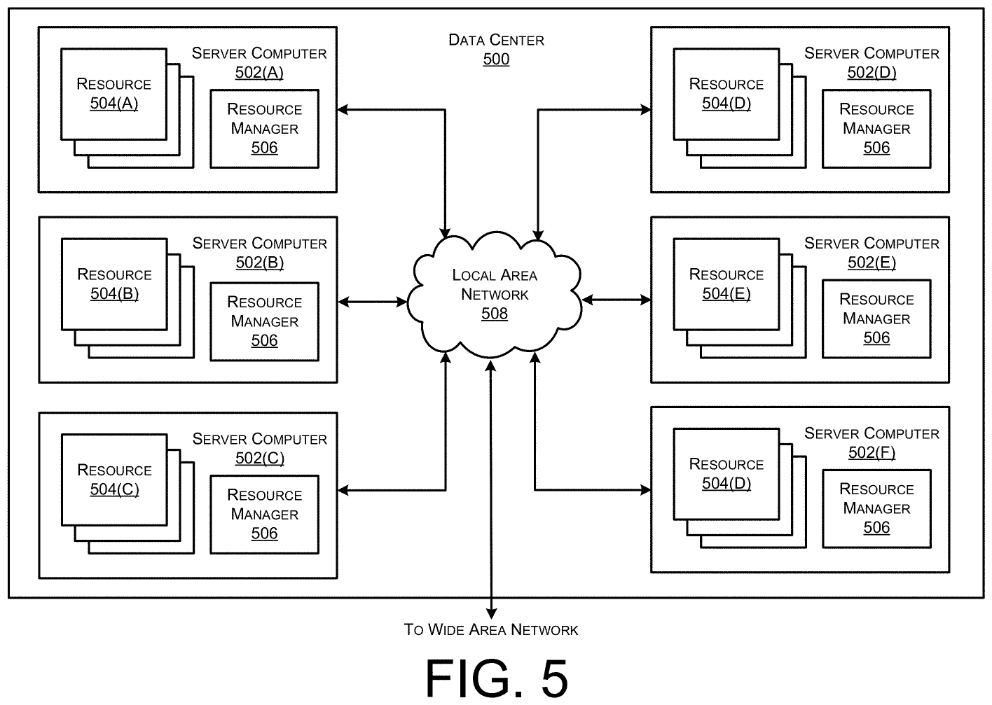

FIG. 5 a computing system diagram illustrating a configuration for a data center 500 that may be utilized to implement aspects of the technologies disclosed herein. The example data center 500 shown in FIG. 5 includes several server computers 502A-502F (which might be referred to herein singularly as “a server computer 502” or in the plural as “the server computers 502) for providing computing resources. In some examples, the resources and/or server computers 502 may include, or correspond to, any type of networked device described herein. Although described as servers, the server computers 502 may comprise any type of networked device, such as servers, switches, routers, hubs, bridges, gateways, modems, repeaters, access points, etc.

The server computers 502 may be standard tower, rack-mount, or blade server computers configured appropriately for providing computing resources. In some examples, the server computers 502 may provide computing resources 504 including data processing resources such as VM instances or hardware computing systems, database clusters, computing clusters, storage clusters, data storage resources, database resources, networking resources, virtual private networks (VPNs), and others. Some of the server computers 502 may also be configured to execute a resource manager 506 capable of instantiating and/or managing the computing resources. In the case of VM instances, for example, the resource manager 506 may be a hypervisor or another type of program configured to enable the execution of multiple VM instances on a single server computer 502. Server computers 502 in the data center 500 may also be configured to provide network services and other types of services.

In the example data center 500 shown in FIG. 5, an appropriate LAN 508 is also utilized to interconnect the server computers 502A-502F. It may be appreciated that the configuration and network topology described herein has been greatly simplified and that many more computing systems, software components, networks, and networking devices may be utilized to interconnect the various computing systems disclosed herein and to provide the functionality described above. Appropriate load balancing devices or other types of network infrastructure components may also be utilized for balancing a load between data centers 500, between each of the server computers 502A-502F in each data center 500, and, potentially, between computing resources in each of the server computers 502. It may be appreciated that the configuration of the data center 500 described with reference to FIG. 5 is merely illustrative and that other implementations may be utilized.

In some examples, the server computers 502 and or the computing resources 504 may each execute/host one or more tenant containers and/or virtual machines to perform techniques described herein.

In some instances, the data center 500 may provide computing resources, like tenant containers, VM instances, VPN instances, and storage, on a permanent or an as-needed basis. Among other types of functionality, the computing resources provided by a cloud computing network may be utilized to implement the various services and techniques described above. The computing resources 504 provided by the cloud computing network may include various types of computing resources, such as data processing resources like tenant containers and VM instances, data storage resources, networking resources, data communication resources, network services, VPN instances, and the like.

Each type of computing resource 504 provided by the cloud computing network may be general-purpose or may be available in a number of specific configurations. For example, data processing resources may be available as physical computers or VM instances in a number of different configurations. The VM instances may be configured to execute applications, including web servers, application servers, media servers, database servers, some or all of the network services described above, and/or other types of programs. Data storage resources may include file storage devices, block storage devices, and the like. The cloud computing network may also be configured to provide other types of computing resources 504 not mentioned specifically herein.

The computing resources 504 provided by a cloud computing network may be enabled in one example by one or more data centers 500 (which might be referred to herein singularly as “a data center 500” or in the plural as “the data centers 500). The data centers 500 are facilities utilized to house and operate computer systems and associated components. The data centers 500 typically include redundant and backup power, communications, cooling, and security systems. The data centers 500 may also be located in geographically disparate locations. One illustrative example for a data center 500 that may be utilized to implement the technologies disclosed herein is described herein with regard to, for example, FIGS. 1, 2 and 6.

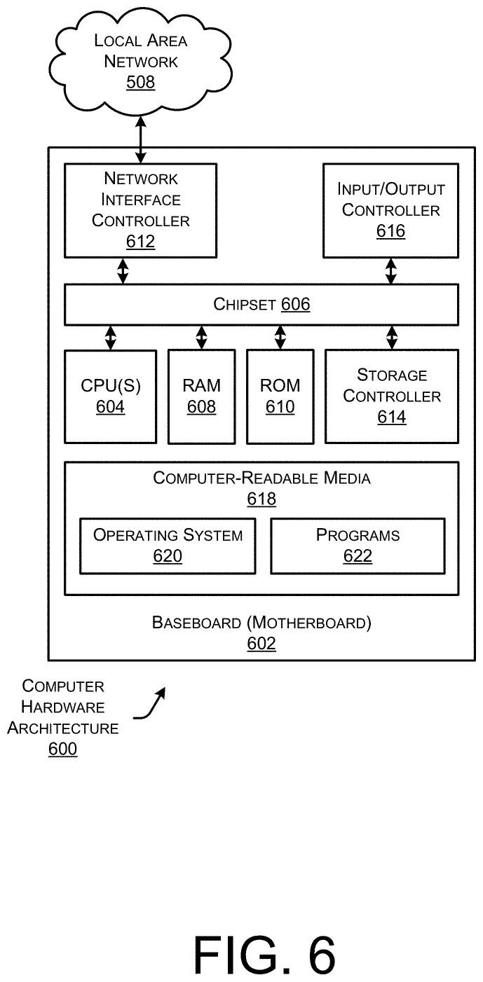

FIG. 6 illustrates a computer architecture diagram showing an example computer hardware architecture 600 for implementing a computing device that may be utilized to implement aspects of the various technologies presented herein. The computer hardware architecture 600 shown in FIG. 6 illustrates the SD-WAN 120, the network devices 122, the SASE 124, the DNS layer security 126 services, the SWG 128 services, the firewall 130 services, the CASB 132 services, and the ITI 134 services, devices associated with the cloud service 104, the IaaS device 106 (including the TEEP broker 108, the TEE 110, the TEEP agent 112, and the TAs 114), and/or other systems or devices associated with the E-TAM 102 and/or remote from the E-TAM 102, a workstation, a desktop computer, a laptop, a tablet, a network appliance, an e-reader, a smartphone, or other computing device, and may be utilized to execute any of the software components presented herein. The computer 600 may, in some examples, correspond to a network device (e.g., the SASE 124, the E-TAM 102, and/or the IaaS device 106 (and associated devices) described herein, and may comprise networked devices such as servers, switches, routers, hubs, bridges, gateways, modems, repeaters, access points, etc.

The computer 600 includes a baseboard 602, or “motherboard,” which is a printed circuit board to which a multitude of components or devices may be connected by way of a system bus or other electrical communication paths. In one illustrative configuration, one or more central processing units (CPUs) 604 operate in conjunction with a chipset 606. The CPUs 604 may be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 may provide an interface to a RAM 608, used as the main memory in the computer 600. The chipset 606 may further provide an interface to a computer-readable storage medium such as a read-only memory (ROM) 610 or non-volatile RAM (NVRAM) for storing basic routines that help to startup the computer 600 and to transfer information between the various components and devices. The ROM 610 or NVRAM may also store other software components necessary for the operation of the computer 600 in accordance with the configurations described herein.

The computer 600 may operate in a networked environment using logical connections to remote computing devices and computer systems through a network, such as the WSN 100. The chipset 606 may include functionality for providing network connectivity through a Network Interface Controller (NIC) 612, such as a gigabit Ethernet adapter. The NIC 612 is capable of connecting the computer 600 to other computing devices over the WSN 100. It may be appreciated that multiple NICs 612 may be present in the computer 600, connecting the computer to other types of networks and remote computer systems. In some examples, the NIC 612 may be configured to perform at least some of the techniques described herein, such as packet redirects and/or other techniques described herein.

The computer 600 may be connected to a storage device 618 that provides non-volatile storage for the computer. The storage device 618 may store an operating system 620, programs 622, and data, which have been described in greater detail herein. The storage device 618 may be connected to the computer 600 through a storage controller 614 connected to the chipset 606. The storage device 618 may consist of one or more physical storage units. The storage controller 614 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computer 600 may store data on the storage device 618 by transforming the physical state of the physical storage units to reflect the information being stored. The specific transformation of physical state may depend on various factors, in different examples of this description. Examples of such factors may include, but are not limited to, the technology used to implement the physical storage units, whether the storage device 618 is characterized as primary or secondary storage, and the like.

For example, the computer 600 may store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 may further read information from the storage device 618 by detecting the physical states or characteristics of one or more particular locations within the physical storage units.

In addition to the storage device 618 described above, the computer 600 may have access to other computer-readable storage media to store and retrieve information, such as program modules, data structures, or other data. It may be appreciated by those skilled in the art that computer-readable storage media is any available media that provides for the non-transitory storage of data and that may be accessed by the computer 600. In some examples, the operations performed by the WSN 100 and or any components included therein, may be supported by one or more devices similar to computer 600. Stated otherwise, some or all of the operations performed by the WSN 100, and or any components included therein, may be performed by one or more computer devices operating in a cloud-based arrangement.

By way of example, and not limitation, computer-readable storage media may include volatile and non-volatile, removable and non-removable media implemented in any method or technology. Computer-readable storage media includes, but is not limited to, RAM, ROM, erasable programmable ROM (EPROM), electrically-erasable programmable ROM (EEPROM), flash memory or other solid-state memory technology, compact disc ROM (CD-ROM), digital versatile disk (DVD), high definition DVD (HD-DVD), BLU-RAY, or other optical storage, magnetic cassettes, magnetic tape, magnetic disk storage or other magnetic storage devices, or any other medium that may be used to store the desired information in a non-transitory fashion.

As mentioned briefly above, the storage device 618 may store an operating system 620 utilized to control the operation of the computer 600. According to one example, the operating system 620 comprises the LINUX operating system. According to another example, the operating system comprises the WINDOWS® SERVER operating system from MICROSOFT Corporation of Redmond, Wash. According to further examples, the operating system may comprise the UNIX operating system or one of its variants. It may be appreciated that other operating systems may also be utilized. The storage device 618 may store other system or application programs and data utilized by the computer 600.

In one example, the storage device 618 or other computer-readable storage media is encoded with computer-executable instructions which, when loaded into the computer 600, transform the computer from a general-purpose computing system into a special-purpose computer capable of implementing the examples described herein. These computer-executable instructions transform the computer 600 by specifying how the CPUs 604 transition between states, as described above. According to one example, the computer 600 has access to computer-readable storage media storing computer-executable instructions which, when executed by the computer 600, perform the various processes described above with regard to FIGS. 1-6. The computer 600 may also include computer-readable storage media having instructions stored thereupon for performing any of the other computer-implemented operations described herein.

The computer 600 may also include one or more input/output controllers 616 for receiving and processing input from a number of input devices, such as a keyboard, a mouse, a touchpad, a touch screen, an electronic stylus, or other type of input device. Similarly, an input/output controller 616 may provide output to a display, such as a computer monitor, a flat-panel display, a digital projector, a printer, or other type of output device. It will be appreciated that the computer 600 might not include all of the components shown in FIG. 6, may include other components that are not explicitly shown in FIG. 6, or might utilize an architecture completely different than that shown in FIG. 6.

As described herein, the computer 600 may comprise one or more of the SD-WAN 120, the network devices 122, the SASE 124, the DNS layer security 126 services, the SWG 128 services, the firewall 130 services, the CASB 132 services, and the ITI 134 services, devices associated with the cloud service 104, the IaaS device 106 (including the TEEP broker 108, the TEE 110, the TEEP agent 112, and the TAs 114), and/or other systems or devices associated with the E-TAM 102 and/or remote from the E-TAM 102. The computer 600 may include one or more hardware processor(s) such as the CPUs 604 configured to execute one or more stored instructions. The CPUs 604 may comprise one or more cores. Further, the computer 600 may include one or more network interfaces configured to provide communications between the computer 600 and other devices, such as the communications described herein as being performed by the E-TAM 102, the SASE 124, the cloud service 104, the IaaS device 106, and other devices described herein. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure for an enhanced trusted application manager E-TAM 102 which will be offered through the SASE 124 and provides services of the E-TAM 102 captured in TEEP specifications along with an additional intelligence of enforcing the policy defined by the enterprise for effectively managing TAs 114 by gleaning intelligence from other security functions offered through the SASE 124. The programs 622 may enable the devices described herein to perform various operations.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure, and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative some examples that fall within the scope of the claims of the application.

What is claimed is:

1. A trusted application manager (TAM) device comprising:
a processor; and
a non-transitory computer-readable media storing instructions that, when executed by the processor, causes the processor to perform operations comprising:
obtaining, from a secure access service edge (SASE) device executing a security service, a data set defining intelligence provided by the security service;
defining a policy based at least in part on the intelligence provided by the security service; and
managing a trusted application (TA) based on the policy.

2. The TAM device of claim 1, wherein managing the TA includes:
installing the TA on a trusted execution environment (TEE) executed on an infrastructure as a service (IaaS) device based at least in part on the policy;
identifying reserved hardware of the IaaS device onto which the TA is to be installed; and
initiating a TA install message to a trusted execution environment provisioning (TEEP) agent via a TEEP broker of the IaaS device to install the TA on the reserved hardware.

3. The TAM device of claim 1, the operations further comprising:
communicating with a TEEP broker of an IaaS device, the communication including an authentication certificate; and
authenticating the TAM with respect to a TEEP agent of the IaaS based at least in part on the authentication certificate.

4. The TAM device of claim 1, wherein the security service executed by the SASE includes a domain name system (DNS) layer security service, a secure web gateway (SWG) service, a firewall service, a cloud access security broker (CASB), an interactive threat intelligence service, and combinations thereof.

5. The TAM device of claim 1, the operations further comprising:
storing the intelligence of the security service in a data store; and
storing the policy in the data store.

6. The TAM device of claim 1, the operations further comprising:
identifying a malicious TA based at least in part on the intelligence of the security service; and
blocking the malicious TA from install on a TEE based at least in part on the policy.

7. The TAM device of claim 1, the operations further comprising:
identifying malicious content of the TA based at least in part on the intelligence of the security service; and
blocking the malicious content from access to a TEE based at least in part on the policy.

8. The TAM device of claim 1, the operations further comprising:
periodically inspecting the TA for a compromise to the TA based at least in part on the intelligence of the security service; and
correcting the compromise to the TA based at least in part on the policy.

9. The TAM device of claim 1, the operations further comprising:
detecting a change to the policy made by the SASE with respect to the TA; and
managing the TA based on the change to the policy.

10. A method comprising:
obtaining, at a trusted application manager (TAM) and from a secure access service edge (SASE) device executing a security service, intelligence data provided by the security service;
defining a policy based at least in part on the intelligence data provided by the security service; and
managing a trusted application (TA) based on the policy.

11. The method of claim 10, further comprising:
installing the TA on a trusted execution environment (TEE) executed on an infrastructure as a service (IaaS) device based at least in part on the policy;
identifying reserved hardware of the IaaS device onto which the TA is to be installed; and
initiating a TA install message to a trusted execution environment provisioning (TEEP) agent via a TEEP broker of the IaaS device to install the TA on the reserved hardware.

12. The method of claim 10, further comprising authenticating the TAM with respect to a TEEP agent of an IaaS device based at least in part on an authentication certificate, wherein the authentication certificate being added to a trusted anchors database of the IaaS device.

13. The method of claim 10, further comprising:
detecting a change to the policy made by the SASE with respect to the TA; and
managing the TA based on the change to the policy.

14. The method of claim 13, wherein the change to the policy is affected via access provided to an application service provider (ASP) to the SASE.

15. The method of claim 10, further comprising:
storing authentication certificates in a data store of the TAM, the authentication certificates defining access to hardware of an infrastructure as a service (IaaS) device onto which the TA is installed.

16. A non-transitory computer-readable medium storing instructions that, when executed, causes a processor to perform operations, comprising:
obtaining, at a trusted application manager (TAM) and from a secure access service edge (SASE) device executing a security service, intelligence data provided by the security service;
defining a policy based at least in part on the intelligence data provided by the security service; and
managing a trusted application (TA) based on the policy.

17. The non-transitory computer-readable medium of claim 16, the operations further comprising:
installing the TA on a trusted execution environment (TEE) executed on an infrastructure as a service (IaaS) device based at least in part on the policy;
identifying reserved hardware of the IaaS device onto which the TA is to be installed; and
initiating a TA install message to a trusted execution environment provisioning (TEEP) agent via a TEEP broker of the IaaS device to install the TA on the reserved hardware.

18. The non-transitory computer-readable medium of claim 16, the operations further comprising authenticating the TAM with respect to a TEEP agent of an IaaS device based at least in part on an authentication certificate, wherein the authentication certificate being added to a trusted anchors database of the IaaS device.

19. The non-transitory computer-readable medium of claim 16, the operations further comprising:
detecting a change to the policy made by the SASE with respect to the TA; and
managing the TA based on the change to the policy.

20. The non-transitory computer-readable medium of claim 19, wherein the change to the policy is affected via access provided to an application service provider (ASP) to the SASE.
